(19) United States
(12) Patent Application Publication
(10) Pub. No.: US 2002/0006273 A1
(43) Pub. Date: Jan. 17, 2002

(54) High-density recording medium having data format acceptable to a digital television and a data reproducing apparatus thereof

(75) Inventors: Kang Soo Seo, Kyunggi-do (KR); Jea Yong Yoo, Seoul (KR); Byung Jin Kim, Kyunggi-do (KR); Hyung Sun Kim, Seoul (KR)

Correspondence Address: JONATHAN, KANG, ESQ., LEE & HONG P.C., 11th Floor, 221 N. Figueroa Street, Los Angeles, CA, 90012-2601, US

(73) Assignee: LG Electronics Inc.

(21) Appl. No.: 09/861,813

(22) Filed: May 21, 2001

(30) Foreign Application Priority Data
May 23, 2000 (KR) 00-27829

(51) Int. Cl. H04N 5/92; H04N 5/781

(52) U.S. Cl. 386/96; 385/125

(57) ABSTRACT

The present invention relates to a high-density recording medium and a data reproducing apparatus thereof. A high-density recording medium of the present invention includes audio and video data which has been recorded thereon in the format of TS (Transport Stream) which is specified as an acceptable input format in the standard of a digital television, and a data reproducing apparatus of reproducing such-recorded recording medium according to the present invention transmits read presentation data from the high-density recording medium without re-encoding and TS multiplexing to a digital television connected through a digital interface IEEE 1394. Due to the present invention, it is possible to deliver high-quality digital data recorded in a high-density recording medium to a digital television without an A/V encoding hardware requiring very complicated algorithm.

### BACKGROUND OF THE INVENTION

1. Field of the Invention

The present invention relates to a recording medium having data format directly acceptable to a digital television expecting TS (Transport Stream) of MPEG format as input data, and a data reproducing apparatus thereof.

2. Description of the Related Art

Recently, the technology of a disk recording medium has been developed remarkably, so that storage capacity has been increased from about 600 Mbytes to about 4.7 Gbytes due to a newly-developed recording medium, DVD (Digital Versatile Disk). As a result, it is possible to record in a DVD about 135 minute-long data consisting of MPEG II formatted video and AC-3 formatted audio data.

In the meantime, a digital television is being gradually commercialized, so that moving pictures whose quality is corresponding to HD (High Definition) grade are sometimes provided. However, new recording medium is required to record HD-grade moving pictures for long time. Therefore, many companies are developing a HD-DVD (High-Density Digital Versatile Disk).

According to a tentative standard for a HD-DVD, it has about 15 Gbyte storage capacity which is 3.2 times of a conventional DVD. The capacity of 15 Gbytes is able to store about 135 minute-long moving pictures of HD-grade.

However, the format of data to record in a HD-DVD is not defined yet, so that it may be considered to use the existing data format of a conventional DVD as that of a HD-DVD. The reproduction operation of a HD-DVD is explained in detail hereinafter on the assumption that a HD-DVD has DVD-compatible data format, that is, the format of PS (Program Stream).

FIG. 1 is a block diagram of a disk device using a disk recording medium. In the disk device of FIG. 1, a PS multiplexer 2 converts video, audio, and sub-picture data into PS of MPEG format. The data to convert into PS may include screen decorating data such as highlighting data. The PS-formatted data are written in a HD-DVD 1 through a pickup.

When the HD-DVD 1 is reproduced, a PS demultiplexer 3 separates data stream read by the pickup into video, audio, sub-picture, and presentation control data, if any. Each separated data stream is applied to corresponding decoder, that is, video decoder 4, audio decoder 5, or sub-picture decoder 6. Each decoder restores input data to uncompressed original data. The sub-picture decoder 6 decodes screen decorating data as well as sub-picture data. The decoded video and sub-picture data are then added in a mixer 10. The mixer 10 also adds OSD (On Screen Display) data if it is needed to display.

The audio and the mixed video data are encoded again into MPEG II-formatted video and AC3-formatted audio data by a MPEG II video encoder 7 and an AC-3 audio encoder 8, respectively. The encoded video and audio data are reformatted to TS (Transport Stream) by a TS multiplexer 9 to be accepted by a high-quality displaying apparatus such as a digital television.

If the data format compatible with a conventional DVD is used for a HD-DVD, it would be configured hierarchically as shown in FIG. 2. The DVD-compatible data format has two recording partitions, one is for file system area, the other for user data zone. One or more video titles are recorded in the user data zone wherein each video title consists of navigation data for reproduction control and presentation data. The presentation data are written in the unit of PS pack whose size is 2048 bytes. Each PS pack is composed of a pack header and pack data area. PES (Packetized Elementary Stream)-formatted data, which includes video, audio, sub-picture, and screen decorating data, are written in that pack data area.

If a HD-DVD whose data are structured as aforementioned is reproduced, the data decoded finally are in PES format which is not acceptable to a digital television. Therefore, as explained above, the decoded data should be re-encoded through the A/V encoders 7 and 8 and then converted into TS by the TS multiplexer 9. The converted TS is transmitted to a digital television connected through a digital interface such as IEEE 1394.

To be brief, if DVD-compatible data format is also used for a HD-DVD, additional A/V re-encoding devices to be implemented with very complicated algorithm should be equipped in a HD-DVD reproducing apparatus in order that A/V data recorded in a HD-DVD might be presented in a digital television.

In addition, a digital television can not process sub-picture and OSD data from other device and not conduct still operation for menu screen with data provided from external device, either. Therefore, a disk reproducing apparatus should convert sub-picture and OSD data into TS through re-encoding and TS multiplexing as explained above and repeat such operations for same video data to implement a still picture such as menu screen at a digital television.

These factors inevitably leads to drawback that re-encoding and TS converting hardware, which is very complicated, is requisite for the decoded data.

### SUMMARY OF THE INVENTION

It is an object of the present invention to record audio and video data in a high-density recording medium in the format of transport stream which is directly acceptable to a digital television.

It is another object of the present invention to provide a data reproducing apparatus which transmits presentation data stream reproduced from the high-density recording medium to a digital television without re-encoding and TS multiplexing of decoded data.

A high-density recording medium according to the present invention, includes audio and video data which has been recorded thereon in the format of transport stream which is specified as an acceptable input format in the standard of a digital television.

An apparatus for reproducing data stream from a high-density recording medium according to the present invention, comprises a data separator separating data stream reproduced from the recording medium into navigation and presentation data, and slicing the presentation data into transport packets; and a interfacing unit transmitting the transport packets sequentially to an external displaying apparatus through a digital interface.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 is a block diagram of a disk device using a disk recording medium;

FIG. 2 shows data recording format compatible with a conventional DVD;

FIG. 3 is a schematic block diagram to record A/V data in a HD-DVD in the data format acceptable to a digital television according to the present invention;

FIG. 4 shows data recording format, which is directly acceptable to a digital television, according to the present invention; and

FIG. 5 is a block diagram of a HD-DVD player being able to reproduce a HD-DVD whose data has been recorded according to the present invention.

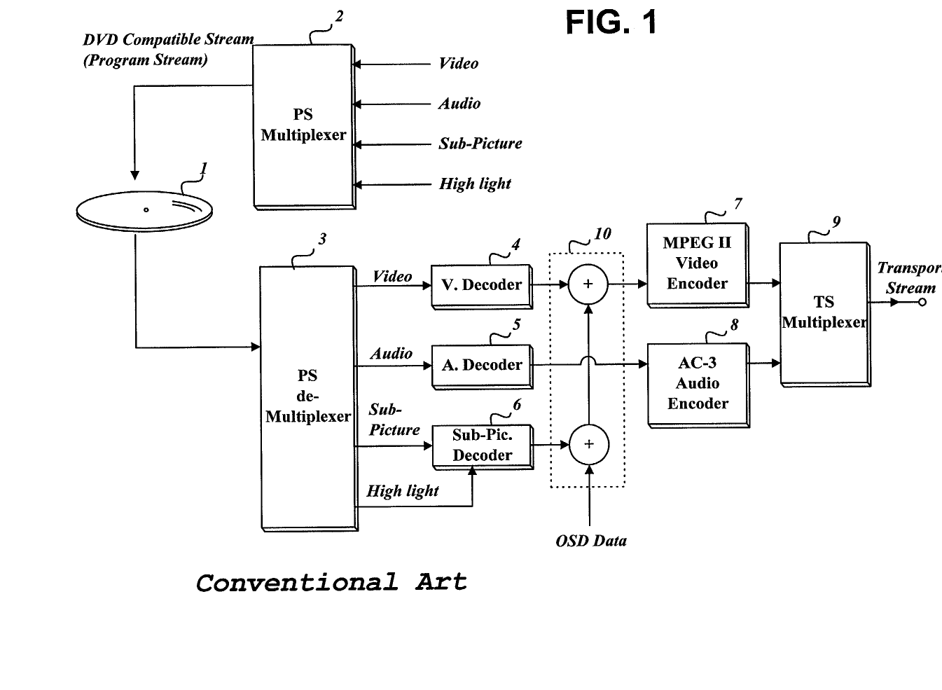

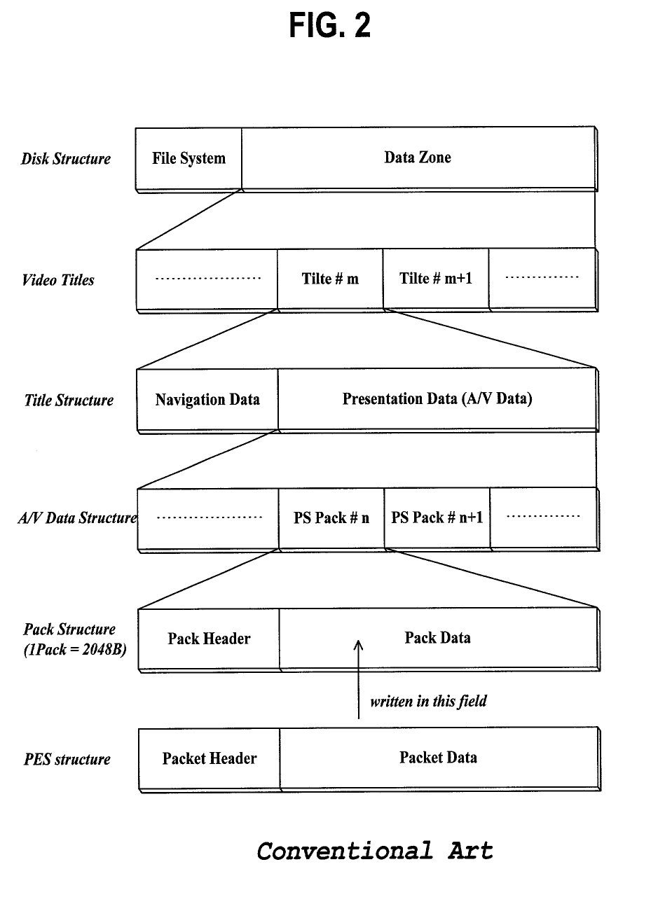

### DETAILED DESCRIPTION OF THE PREFFERRED EMBODIMENT

In order that the invention may be fully understood, a preferred embodiment thereof will now be described with reference to the accompanying drawings.

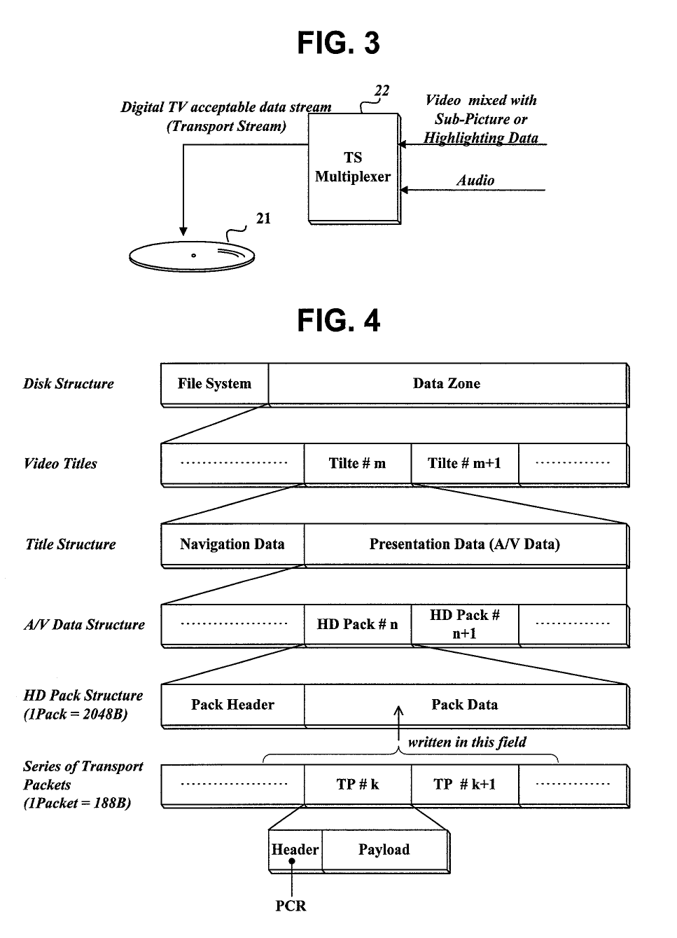

FIG. 3 is a schematic block diagram to record A/V data in a HD-DVD in the data format acceptable to a digital television. In the recording apparatus of FIG. 3, a TS multiplexer 22 multiplexes encoded video and audio data received from an external data source and records the multiplexed data in a HD-DVD 21 in the TS format which is series of transport packets (TPs). Encoded sub-picture data and screen decorating data, if necessary, are added in the encoded video data prior to multiplexing of the TS multiplexer 22.

That is, to record video and audio data in the HD-DVD 21 in the acceptable format to a digital television, sub-picture or highlighting data for menu or text caption are mixed with video data before the video data are applied to the TS multiplexer 22. Therefore, audio and video data including sub-picture and screen decorating data are recorded in the HD-DVD 21 in the TS format.

Instead of mixing sub-picture data etc. with video data, sub-picture and highlighting data may be recorded in the TS format with separation from the video and audio data. In this case, sub-picture and highlighting data are read in advance before reproducing video and audio data. However, some of sub-picture data or highlighting data are transmitted with corresponding video and audio data reproduced from the HD-DVD 21. If highlighting data are not recorded in the TS format, it may be delivered to a digital television through an auxiliary channel other than data channel. The auxiliary channel may be asynchronous channel of IEEE 1394 standard.

In the meantime, audio, video and navigation data for presentation control have recording structure being able to support still picture when it is presented in a connected digital television.

If input data are written in a HD-DVD in the format acceptable to a digital television, the recorded structure would be configured hierarchically as shown in FIG. 4. The recorded structure has two recording partitions, one is for file system area, the other for user data zone. One or more video titles are recorded in the user data zone wherein each video title consists of navigation data for reproduction control and presentation data. The presentation data are written in the unit of HD (High-Density) pack whose size is 2048 bytes, and each HD pack is composed of a pack header and a pack data area. Several TPs (Transport Packets) are written in that pack data area. Each TP, whose size is 188 bytes, is composed of a packet header which may include PCR (Program Clock Reference) and payload field which includes valid presentation data.

The standard for a digital television, for example, A/53 (ATSC Digital Television Standard) adopted in USA specifies that TS, that is, series of 188 byte-long TPs should be directly accepted in a digital television.

It is considered that data recorded in a HD-DVD is to be presented in a digital television observing European or Japanese standard, TPs of presentation data are to be written in a HD-DVD in the format specified in the corresponding standard of a digital television.

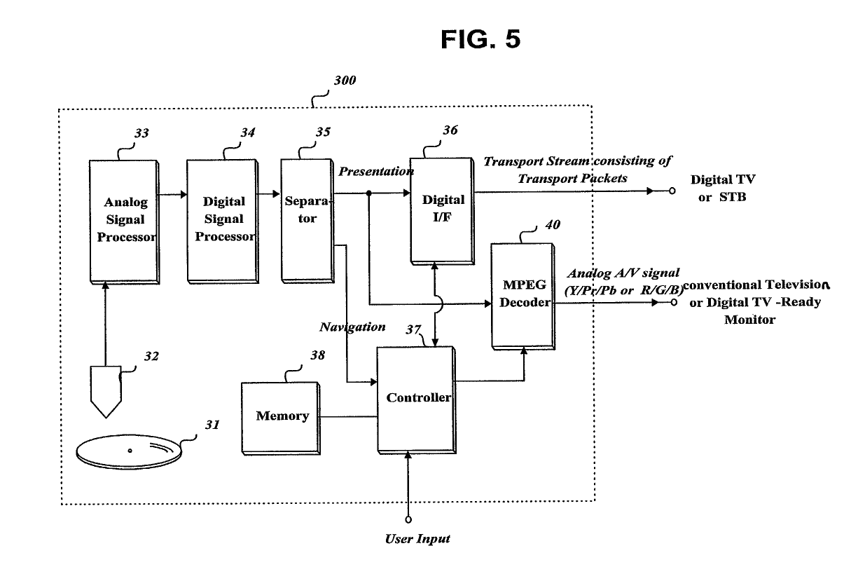

FIG. 5 is a block diagram of a HD-DVD player being able to reproduce a HD-DVD whose recording format is same as shown in FIG. 4. The HD-DVD player 300 of FIG. 5 comprises a pickup 32 reading data from a HD-DVD 31 whose recorded data has an acceptable format to a digital television; an analog signal processor 33 binarizing the signal outputted from the pickup 32; a digital signal processor 34 demodulating the binarized signal into digital data; a data separator 35 separating demodulated digital data into presentation data including A/V data and navigation data for reproduction control, and slicing the presentation data into series of TPs through analyzing auxiliary information inserted in the presentation data; an interfacing unit 36 sending the TPs at their respective transmitting time interval through IEEE 1394 interface; a controller 37 controlling the above elements according to the navigation data and/or user's commands; and a memory 38 storing data which are necessary for the control operation and are generated in data reproduction. A decoder 40, which can decode TP-formatted presentation data into respective analog video and audio signal, is optionally equipped in the HD-DVD player 300.

If recorded data whose format is serial of TPs are reproduced from the HD-DVD 31 by the pickup 32, presentation data of them are sliced into TPs by the data separator 35, and applied to the interfacing unit 36. The interfacing unit 36 transmits each received TP at time interval given in its header to a connected digital television or a STB (Set Top Box) which has adopted same standard, for example, standard A/53 specifying that TP-formatted data should be accepted as an input source.

The interfacing unit 36 has an internal clock to refer to transmit a TP at its given time interval, and adjusts the internal clock if there is difference between its clock and PCR (Program Reference Clock) written in a TP header when a received TP has a PCR.

According to the above-explained recording and transmitting method, data stream reproduced from the HD-DVD can be delivered to an external digital television without re-encoding and reformatting to TP.

The digital television receiving the TPs extracts sub-picture or highlighting data, if requested to do, from mixed video data, and displays menu with still picture or text captions onto its screen. However, the digital television does not use sub-picture or highlighting data mixed in video data in normal presentation mode.

In the meantime, since the decoder 40 decodes series of TPs constituting presentation data separated in the data separator 35 into respective analog video and audio signal, a conventional television not being able to process series of TPs is connected to the terminal defined as an output of the decoder 40.

The high-density recording medium and data reproducing apparatus thereof, can provide high-quality digital A/V data to a digital television without re-encoding and TS multiplexing of reproduced data, which removes necessity of an A/V encoding hardware requiring very complicated algorithm, and make it possible to implement still picture at a digital television without an additional hardware such as re-encoding logic circuitry.

The invention may be embodied in other specific forms without departing from the sprit or essential characteristics thereof. The present embodiments are Therefore to be considered in all respects as illustrative and not restrictive, the scope of the invention being indicated by the appended claims rather than by the foregoing description and all changes which come within the meaning and range of equivalency of the claims are Therefore intended to be embraced therein.

What is claimed is:

1. A recording medium including audio and video data, wherein the audio and video data are recorded thereon in the format of transport stream which is specified as an acceptable input format in the standard of a digital television.

2. The recording medium set forth in claim 1, wherein said video data includes sub-picture or screen decorating data which are to be presented as a still picture at a digital television, the sub-picture or screen decorating data being displayed as a menu or text caption.

3. The recording method set forth in claim 2, wherein said screen decorating data is for highlighting a window or a text.

4. The recording medium set forth in claim 1, wherein sub-picture or screen decorating data are recorded thereon with separation from said video and audio data, the sub-picture or screen decorating data being displayed as a menu or text caption.

5. The recording method set forth in claim 4, wherein said screen decorating data is for highlighting a window or a text.

6. The recording medium set forth in claim 1, wherein said video and audio data are recorded in the unit of 2048 byte-long pack which is composed of a pack header and a pack data area in which a plurality of 188 byte-long MPEG transport packets are written.

7. An apparatus for reproducing data from a recording medium, comprising:
a data separator separating data stream reproduced from the recording medium into navigation and presentation data, and slicing the presentation data into transport packets; and
a interfacing unit transmitting the transport packets sequentially to an external displaying apparatus through a digital interface.

8. The apparatus set forth in claim 7, wherein the presentation data is composed of audio and video data, the video data including sub-picture data or screen decorating data.

9. The apparatus set forth in claim 7, wherein sub-picture or screen decorating data are reproduced and transmitted with separation from the presentation data composed of video and audio data.

10. The apparatus set forth in claim 7, wherein said interfacing unit transmitting each received 188 byte-long transport packet at time interval given in a header of the transport packet.

11. The method set forth in claim 7, further comprising a data converter decoding the transport packets sliced from the presentation data into respective analog video and audio signal.

12. The apparatus set forth in claim 11, wherein the converted analog video and audio signal are delivered to an external displaying device through a signal path not provided by said interfacing unit.
